(19) United States
(12) Patent Application Publication
(10) Pub. No.: US 2010/0054957 A1
(43) Pub. Date: Mar. 4, 2010

(54) METHOD FOR DETERMINING A STATEMENT OF A STATE OF A TURBOMOLECULAR PUMP AND A TURBOMOLECULAR PUMP

(75) Inventors: Thomas Goetze, Chemnitz (DE); Reiner Hoelzer, Hurth (DE); Christian Harig, Koeln (DE)

Correspondence Address: FAY SHARPE LLP, 1228 Euclid Avenue, 5th Floor, The Halle Building, Cleveland, OH, 44115, US

(73) Assignee: OERLIKON LEYBOLD VACUUM GMBH, KOELN (DE)

(21) Appl. No.: 12/374,917

(22) PCT Filed: Jun. 22, 2007
(86) PCT No.: PCT/EP07/56248

§ 371 Date: Nov. 12, 2009

(30) Foreign Application Priority Data
Jul. 26, 2006 (DE) 10 2006 034 478.2

(51) Int. Cl. F04D 19/04; G01M 19/00

(52) U.S. Cl. 417/53; 417/63; 73/168

(57) ABSTRACT

In a method for determining a statement of a state of a turbomolecular pump, and in a turbomolecular pump, a vibration curve is determined with a vibration sensor (10) connected to the turbomolecular pump. The determined vibration curve is transferred to an evaluation device (12), wherein vibration amplitudes are detected by a filter (16) in the evaluation device (12) and then compared to comparative values. If a threshold value is exceeded, a warning signal is transferred to a monitoring system (30) by a remote data transfer device (28). The method allows for online monitoring of turbomolecular pumps.

### BACKGROUND

The invention relates to a method for determining a statement of a state of a turbomolecular pump, and a turbomolecular pump.

Turbomolecular pumps for generating a high vacuum are provided with fast-rotating pump shafts which are normally supported in ball or slide bearings. Due to the high mechanical stresses acting on the bearings and on other mechanical components of turbomolecular pumps, a sudden fallout of the turbomolecular pump may happen to occur as a consequence of mechanical stresses. A fallout of turbomolecular pumps will sometimes occur spontaneously and unpredictably. Because of the high technical requirements, the operational life of such turbomolecular pumps may vary in wide ranges; thus, a fallout of the turbomolecular pump can be avoided only with difficulties even if regular service intervals are provided, or the service work will have to be performed in extremely short time intervals. A failure of a turbomolecular pump which is operated e.g. in a cleanroom will often necessitate an interruption of the production. Further, a damage in the bearings can often lead to a blocking of the shaft. Due to the large mass inertia, this will cause a partial destruction of the turbomolecular pump.

To avoid a total fallout of the turbomolecular pump, it is required to perform an analysis in brief, regular intervals. It is known to carry out this analysis by examining the turbomolecular pump with the aid of a mobile analysis apparatus. Said analysis apparatus comprises a vibration detector as well as an evaluation device. The vibration detector will be connected to the turbomolecular pump. The detected vibration spectrum will be represented by the evaluation device, e.g. in a diagram. On the basis of the frequency spectrum, the expert can realize whether a damage has occurred to mechanical components, particularly of the bearings, so that a fallout of the pump has to be expected within short. This detection is made possible because, in case of a damaged turbomolecular pump wherein e.g. a bearing has suffered massive wear, it is not only that individual spectral lines will stand out in a very distinct manner but also that an increase of the vibration values will be evident over a broad band of the spectrum. Thus, the checking of turbomolecular pumps requires a complex measurement to be performed on the pump in situ by a specialist. To avoid the risk of total fallout, this procedure has to be carried out in brief, regular intervals. In spite of such a checkup service, total failure of turbomolecular pumps will still occur now and again, entailing the risk of considerable consequential damage.

### SUMMARY

It is an object of the invention to prevent the occurrence of total failure of turbomolecular pumps and particularly to reduce the personnel expenditure for checkup.

According to the invention, there will be determined a statement of a state of a turbomolecular pump. By such a determination process, for instance, it can be detected at an early point of time whether a pump is damaged. Thereby, possible future fallout of the pump can be detected early, thus allowing corresponding countermeasures to be taken. According to the inventive method, a vibration development is detected at least at one frequency with the aid of a vibration detector connected to the turbomolecular pump. Preferably, in the process, the vibration detector is continuously connected to the turbomolecular pump; herein, preferably a mechanical connection is provided to the to-be-monitored components of the turbomolecular pump, particularly to the bearings. Said at least one vibration development detected by the vibration detector is transmitted to an evaluation unit which preferably is also stationary and which is directly connected to the turbomolecular pump. Preferably, the evaluation unit is integrated into the turbomolecular pump, e.g. arranged in the existing control unit of the turbomolecular pump. The evaluation unit comprises a filter, preferably a variable-frequency filter. The filter is set to a frequency, or a frequency is applied to it. Thereby, a corresponding vibration amplitude can be detected. The frequency variation of the filter is carried out by setting different frequencies. In the evaluation unit, the at least one determined vibration amplitude is compared to one or a plurality of limiting values. For instance, these limiting values can be values which have been detected on the basis of a standard vibration development of a pump with undamaged components. Preferably, the limiting values have been detected empirically or are based on empirically detected values, and have been stored in a storage element of the evaluation unit. As soon as a limiting value is exceeded, a warning signal is emitted by the evaluation unit. If desired, a warning signal is output only after the limiting value has been exceeded several times or for a predetermined longer period of time.

According to a particularly preferred variant of the inventive method, the filter used in the method is a filter with variable frequency. Still more preferably, this filter is provided as an integrated frequency-filter circuit. Such an integrated frequency-filter circuit is an inexpensive component. As variable-frequency filters, use is preferably made of so-called “switched capacitor filters” which are available, as a mass-produced article, in the form of highly integrated semiconductor circuits (IC circuits) and which in the relevant technical literature are described e.g. in “Halbleiter-Schaltungstechnik; U. Tietze, Ch. Schenk”. In a switched capacitor filter (SC filter), use is made of the principle of an active filter—designed with operational amplifiers and RC circuits (resistor and capacitor) as an integrator circuit—wherein the frequency-determinant filter time constant “T” is defined not by R*C but by C/(Cs*fs).

It is of particular advantage that the capacitor switching frequency fs at Cs can be generated in a simple, precise and variable manner by usual microcontroller circuits. Further, in integrated semiconductor circuits, capacities can be generated in a very favorable manner. According to the above described principle, the absolute value will not be included in the determination of T while only the ratio will be included, which is very convenient for the realization of the integrated circuit.

Useful switched-capacitor filter ICs are offered by several manufacturers, such as, for instance:

MAXIM company: MAX 7490

suitable for high-pass, low-pass, band-pass and notch filters
in a frequency range of 1 Hz to 40 kHz

and

Linear Technology company: LTC1059

suitable for high-pass, low-pass, band-pass and notch filters
in a frequency range of 0.1 Hz to 40 kHz

By cascading a plurality of SC filter circuits, it becomes possible, if desired, to influence the filter properties under additional aspects, e.g. for obtaining steeper flanks or increased damping.

With particular preference, there is used—in addition to the integrated frequency-filter circuit—also the already existing microprocessor of the turbomolecular pump. In each turbomolecular pump, a microprocessor does already exist for drive control and monitoring. The computing power of the existing microprocessor is used nearly to capacity. The inventive employment of the integrated frequency-filter circuit has the effect of reducing the burden imposed on the internal microprocessor of the turbomolecular pump for performing the analysis, the latter preferably being an FFT analysis. Even though the complete pick-up of a vibration development can take a relatively long time, ranging from several minutes up to even hours, this does not cause a disadvantage in performing the inventive method since turbomolecular pumps are normally incessantly operated over longer periods of time, notably months or years, so that a period of several days will suffice for early detection of a possible fallout.

In a typical microprocessor as normally used in turbomolecular pumps, the herein described method of discrete frequency analysis will require about 1% of the resources and will demand virtually no real-time capability. This has the advantage that, with respect to the vibration pick-up, the microprocessor can be interrupted in any desired manner for the sake of high-priority tasks without causing a noteworthy influence on the measurement.

The inventive method performed using an integrated frequency-filter circuit in connection with the microprocessor already existing in the turbomolecular pump has the essential advantage that, by making use of the still available remaining capacity of the microprocessor in connection with the inexpensive integrated frequency-filter circuit, an online fallout prediction is rendered possible at only little additional cost and with a very compact constructional size.

The limiting value or values can be determined, directly upon manufacture or at the time of initial operation, not only from a standard vibration development of an undamaged pump but also individually for each pump or at least each pump type.

With particular preference, measurement of the vibration amplitudes is performed at a plurality of frequencies. This is preferably carried out by means of the filter to which different frequencies will be applied. Preferably, the vibration amplitudes will subsequently be combined, preferably added to each other. The total value, as preferably obtained by addition, will then be compared, preferably directly, to the limiting value.

Preferably at predetermined time intervals, the vibration amplitudes will be determined at predefined frequencies. In doing so, the vibration amplitudes will in each examination process be determined respectively for the same frequencies, thus allowing for a comparison of the vibration amplitudes and respectively of the overall value detected from the vibration amplitudes. Thus, it is made possible to detect an amplitude change of individual amplitudes or a change of the total value. Then, as a limiting value, also a change of time can be considered instead of, or in addition to, an absolute value. This makes it possible, for instance, to generate a warning signal also when the predetermined limiting value has not yet been exceeded but a fast increase of individual amplitudes or of the total value is detected.

By the adding of a plurality of amplitude values, it is safely precluded that a possible isolated increase of a value, which may have occurred accidentally or as a result of a singular change of conditions, might trigger a warning signal. Since, prior to the fallout of individual components, a large number of individual signal values will increase, e.g. due to enlarged tolerances of the bearings, the differences between the integrated/summed-up value of a plurality of vibration amplitudes of an undamaged pump and the value of a damaged pump will be large. The adding of a plurality of amplitude values will guarantee with high reliability that a warning signal can indeed be emitted only if a service is required. Further, it can be safeguarded that an exceeding of a limiting value is detected early, thus leaving sufficient time for carrying out the service or, if required, for exchanging the pump.

According to the invention, the vibration pick-up and the evaluation unit are permanently connected to the turbomolecular pump so that all turbomolecular pumps which are to be monitored are provided with a corresponding vibration pick-up and an evaluation unit. The determining of the amplitudes can thus be performed continuously or at least at brief intervals. No service personnel is necessitated because the process can be performed automatically. The outputting of the warning signal is preferably effected by remote data transmission to a service facility.

Preferably, the inventive method is performed by use of the processor installed in the turbomolecular pump. This is possible because no extensive computational processes are required for performing the method. Since the expenditure for performing the inventive method is small, the necessary computations can be additionally taken over by the existing microcontroller. Thus, the inventive method can be implemented in existing turbomolecular pumps in a simple and inexpensive manner. It is also not required that the monitoring data are processed quickly, since no direct reaction is needed. The reason for this lies in that, in the inventive method, a possible future fallout is detected at an early point of time, thus obviating the need for an immediate reaction. In the inventive method, the required computational performance as well as the required storage capacity are considerably less than in known FFT methods used for monitoring.

The analysis principle preferably used according to the invention does not involve the use of an FFT analysis (Fast Fourier Transformation) but the determining of the amplitude for each measured frequency range, i.e. each frequency to be analyzed is to be determined individually (discretely). The corresponding detection of data does require a long time, while this, as explained above, causes no disadvantage in the practicing of the invention. In FFT, the signal to be examined is detected in the time domain and, as prescribed by the FFT, converted into a frequency spectrum. In case of a corresponding computational power, this process can be handled very quickly, which, however, is not imperative here.

Thus, according to the invention, the turbomolecular pump can be subjected to online monitoring. This has the advantage of eliminating the need for regular analysis processes performed at brief intervals by a specialist. The personnel demand for performing the analysis work is thus considerably reduced. Instead, the inventive online monitoring makes it possible that, as soon as a warning signal is received from the monitoring unit, a specialist can carry out the maintenance work on the pump. This work can involve the exchange of individual pump components as well as individual bearings. Depending on the given case, even the complete turbomolecular pump can be exchanged so that, if desired, the damaged turbomolecular pump can then be repaired. Due to the online monitoring, a sudden, unexpected total failure is avoided because the exceeding of the limiting values will occur already prior to total failure. For instance, the amplitude at individual frequencies will change as soon as a bearing has been damaged; thus, vibration amplitudes will undergo a change before the bearing suffers a fallout. Thus, sufficient time will be left for carrying out maintenance work, such as e.g. exchanging the bearing.

As the case may be, it can be necessary to switch off the turbomolecular pump. This can be required in dependence on the respective application, e.g. in critical situations during production. Further, a switch-off may be required in dependence on a second—possibly higher—limiting value. In case that a second limiting value is exceeded, it is to be feared that the turbomolecular pump will fall out soon and the required exchange cannot be performed in due time. In such cases, the switch-off can be performed automatically, if desired. In this manner, the occurrence of a total fallout along with consequential damage caused by it, is avoided.

Preferably, a plurality of frequencies are measured in a critical frequency range. The critical frequency range can be empirically detected corresponding to the respective pump. Particularly, the critical frequency range will be in the range of 0.3 to 50 times the rotational frequency, especially 8 to 16 times the rotational frequency. By restricting the measurement to a critical frequency range, a more reliable comparison to the comparison values and thus a more reliable generation of the warning signals can be safeguarded. For example, possibly occurring increased spectral values in other ranges which are not relevant for a service, will be left unconsidered.

Preferably, for the outputting of a warning signal, there are additionally considered also further turbomolecular pump parameters and/or the ambient conditions. Consideration can be given, for instance, to the operating temperature, the operating period, the number of starting cycles, stand-by cycles and load cycles, as well as the load condition. Particularly, it is possible to perform an adaptation of the limiting value in dependence on turbomolecular pump parameters and/or ambient conditions. Thus, the invention offers the possibility to perform a continuous adaptation of the limiting value, the adaptation preferably being performed automatically, with the aid of the evaluation unit and corresponding software stored in the evaluation unit.

Preferably, apart from the transmission of a warning signal to the monitoring unit, a control signal is transmitted to the service facility at regular time intervals. Also the transmission of the control signal is preferably performed through remote data transmission; thus, also the control signals are transmitted online. Thus, the monitoring unit can check whether the evaluation unit is working reliably. A fallout of the evaluation unit could be detected immediately. Particularly, the value obtained by integration can be transmitted by the control signal. Thereby, the monitoring unit can examine whether the transmitted value is plausible. Normally, due to wear, the total value should tend to increase over time. With the aid of a corresponding algorithm, the monitoring unit can examine the plausibility of the transmitted values. Such a plausibility check can also be carried out immediately in the evaluation unit.

The invention further relates to a turbomolecular pump which according to the invention is modified to be suitable for performing the above described method. Said turbomolecular pump comprises, within a housing, a pumping device having fast-rotating shafts and corresponding bearings. A vibration pick-up is mechanically connected to the components of the turbomolecular pump which are to be monitored, particularly to the individual bearings. Of course, the vibration pick-up can be mechanically connected also to a plurality of components which are to be monitored. According to the invention, the vibration pick-up forms a part of the turbomolecular pump and, particularly, is arranged within the housing of the turbomolecular pump. This has the advantage that a good mechanical connection to the monitored components is provided. The integration of the vibration pick-up into the turbomolecular pump further allows for a continuous or at least frequent pick-up of the vibrations. Useful as vibration pick-ups are acceleration pick-ups, Piezo knock sensors, body/air sound microphones, distance sensors etc.

Further, the turbomolecular pump of the invention is provided with an evaluation unit which is electronically connected to the vibration pick-up. Preferably, said evaluation unit is integrated into an existing control unit of the turbomolecular pump. The evaluation unit preferably uses existing components of the control unit such as e.g. the microprocessor and/or the memory.

Preferably, the evaluation unit comprises a filter to which a frequency is applied. In this manner, a corresponding vibration amplitude can be filtered out, in order to be compared to a limiting value, as described above in connection with the method. Particularly, the filter is variable by application of different frequencies thereto.

According to the invention, the evaluation unit is connected to an output device for outputting a warning signal. A warning signal will be generated when a limiting value is exceeded; said limiting value is obtained by comparing signals outputted by the vibration pick-up, to comparison values which are preferably stored in the evaluation unit. Preferably, the output device is designed as an interface for transmitting the warning signal, preferably by data transmission, to a monitoring unit.

By the inventive integration of the vibration pick-up into the turbomolecular pump as well by as the immediate connection of the evaluation unit to the turbomolecular pump particularly by integration into the existing control unit, there is made possible a continuous or at least frequent maintenance to performed on the turbomolecular pump by detection of a vibration spectrum and corresponding evaluation of the vibration spectrum. Thus, for monitoring the turbomolecular pump, it is not required to connect an external monitoring unit to the turbomolecular pump and to have the monitoring performed by an expert. Instead, it is possible to carry out an online monitoring process in a quite simple manner. Thereby, the occurrence of a total fallout along with the resultant consequential damage is avoided.

The evaluation unit preferably comprises a microprocessor and/or a storage element. Preferably, use is made of the components existing in the control unit of the turbomolecular pump. This allows for a considerable cost reduction.

According to a particularly preferred embodiment of the inventive turbomolecular pump, the filter is provided in the form of an integrated frequency-filter circuit which preferably is configured in the manner described above in connection with the method. Preferably, one will use the microprocessor which is already included in the turbomolecular pump for drive control and monitoring, as described above in connection with the method.

Additionally, for determining additional turbomolecular pump parameters and/or for determining ambient conditions, a determining device can be provided. With the aid of said determining device, which preferably forms a part of the evaluation unit, the turbomolecular pump parameters and respectively the ambient conditions can be considered in the outputting of the warning signal. Particularly, an adapting of the limiting values can be performed by a limiting-value adapting device integrated into the evaluation unit.

The following is a detailed description of an embodiment of the invention with reference to the drawings.

### BRIEF DESCRIPTION OF THE DRAWINGS

In the drawings, the following is shown:

FIG. 1 is a schematic representation of the individual components for realizing the invention;

FIG. 2 is a basic diagram of a vibration spectrum, as detected by a vibration pick-up, of a pump with undamaged bearing, and

FIG. 3 is a basic diagram of a vibration spectrum, as detected by a vibration pick-up, of a pump with damaged bearing.

### DETAILED DESCRIPTION

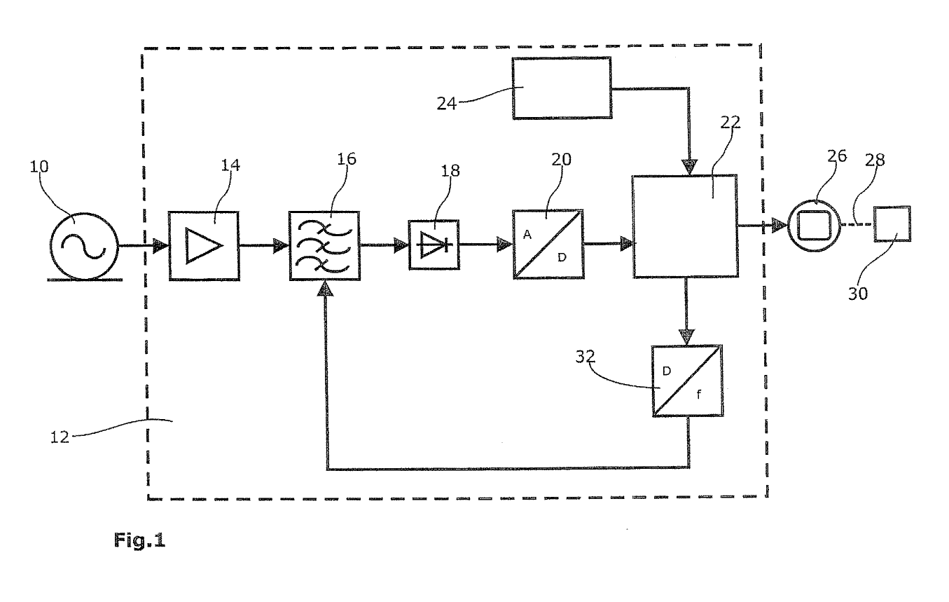

In the schematic representation of the individual components (FIG. 1), there is shown a vibration pick-up 10 mechanically connected to the components of the turbomolecular pump which are to be monitored, particularly to the bearings. The vibration pick-up is operative to pick up mechanical vibrations and to convert them into an electric signal. Said electric signal is transmitted to an evaluation unit 12. In the illustrated embodiment, the evaluation unit 12 comprises an amplifier 14 by which the voltage amplitude is increased. Amplifier 14 is connected to a frequency filter 16 which preferably is an integrated frequency-filter circuit. With the aid of a frequency filter 16, the individual interesting amplitudes of the electric vibration signals will be filtered out. Preferably, the frequency filter 16 is variable by applying different frequencies thereto. With the aid of a signal rectifier 18 arranged behind frequency filter 16, the filtered vibration signal will be converted into a direct-voltage signal. In an analog/digital converter 20 connected to signal rectifier 18, said direct-voltage signal will be converted to a digital value. This digital value will then be processed by a microprocessor 22. Preferably, said microprocessor 22 is the microprocessor already existing in the turbomolecular pump for performing the principle tasks, such as e.g. drive control and monitoring.

Further, a memory 24 is connected to microprocessor 22. Stored in said memory 24 are the comparison values so that the present vibration amplitude which has been detected by the vibration pick-up 10 and has been processed as described above, can be compared to comparison values. If the comparison performed by microprocessor 22 evidences that a limiting value is exceeded, a warning signal will be output to an output device 26. Said output device 26 is connected to a monitoring unit 30 via a remote data transmission system 28. Said monitoring unit 30 is preferably a service provider such as e.g. a service center, and thus does not need to be arranged within the premises of the company.

Further, microprocessor 22 can be connected to a determining device, not illustrated, for determining further parameters of the turbomolecular pump and/or for determining ambient conditions. The corresponding parameters can be considered in the detection of the warning signal and respectively in the determining of the limiting value.

For setting the filter-frequency characteristic of frequency filter 16, microprocessor 22 will transmit a numerical value to a digital-value frequency converter 32. On the basis of said numerical value, the digital-value frequency converter 32 will detect an equivalent frequency to be used for setting the filter characteristic of filter 16. Thus, the filter characteristic can be adapted depending on the requirement profile.

The individual vibration amplitudes which have been measured at predetermined frequencies are preferably added up by the microprocessor 22. The total value obtained by this add-up process will then be compared to one or a plurality of limiting values. Then, e.g. when a first limiting value is exceeded, a signal will be generated which will initiate a service or maintenance process to be performed on the turbomolecular pump. As soon as e.g. a second, higher limiting value is exceeded, the turbomolecular pump will be switched off, preferably automatically.

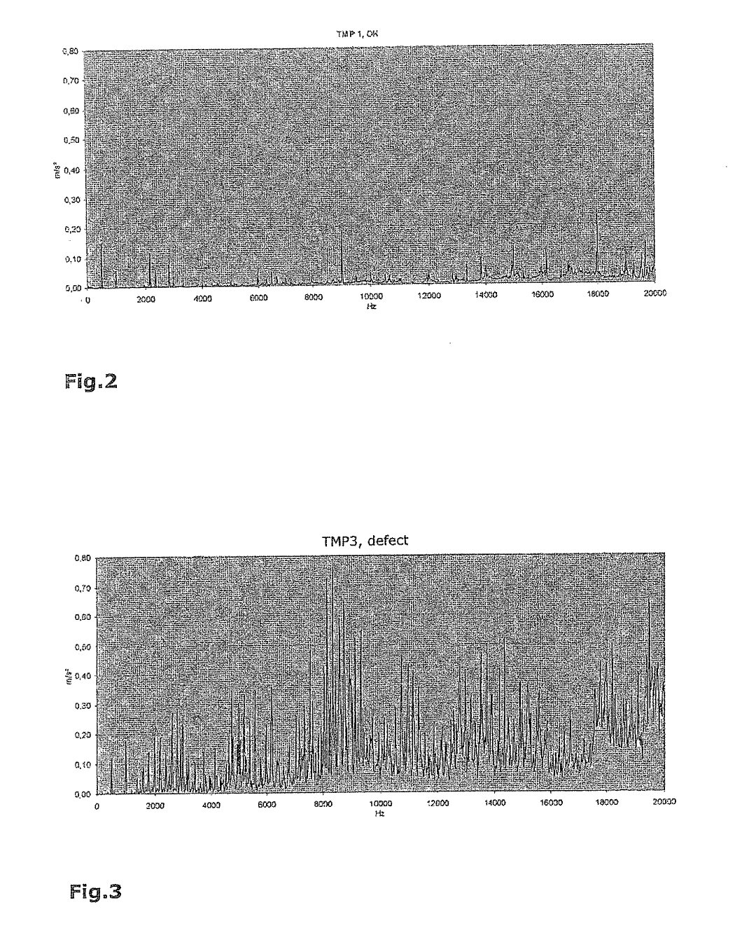

For illustrative purposes, FIG. 2 shows a diagram of a vibration spectrum. This spectrum is the vibration spectrum of a correctly working turbomolecular pump wherein no bearings have been damaged and no other mechanically relevant components have been damaged either.

FIG. 3, by contrast, shows a vibration spectrum of a turbomolecular pump with damaged bearing. From this Figure, it is clearly evident that the amplitude of individual vibrations is increased. By the inventive adding of individual vibration amplitudes e.g. in the range of 8,000 to 20,000 Hz at a frequency interval of e.g. 50 Hz, it can be easily detected, by comparison to a limiting value, that the given turbomolecular pump has a damaged bearing.

For further refinement of the method, it can be provided that amplitudes below a limiting value of e.g. 0.1 m/s² will not be considered. This has the consequence that vibrations which would also occur in turbomolecular pumps with undamaged bearings and like components, will not be considered.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. A method for determining a statement of a state of a turbomolecular pump, wherein
a vibration development is detected by a vibration pick-up connected to the turbomolecular pump,
said vibration development is communicated to an evaluation unit,
the evaluation unit has arranged therein a filter, preferably a frequency-filter circuit, said filter being set to a frequency for detecting a corresponding vibration amplitude,
in said evaluation unit, the current vibration amplitude is compared to at least one limiting value with the aid of a microprocessor of the turbomolecular pump, and
a signal is transmitted to a monitoring device when said limiting value is exceeded.

2-20. (canceled)

21. The method according to claim 1, wherein said filter is frequency-variable by setting different frequencies.

22. The method according to claim 1, wherein the signal transmitted when the limiting value is exceeded, is transmitted via a data transmission system.

23. The method according to claim 1, wherein the vibration amplitudes are measured at a plurality of frequencies and the measured vibration amplitudes are combined to a total value.

24. The method according to claim 23, wherein said total value is determined by adding up the individual measured vibration amplitudes.

25. The method according to claim 23, wherein a plurality of frequencies in a critical frequency range are measured, said critical frequency range being preferably in the range of 0.3 to 50 times the rotational frequency of the turbomolecular pump.

26. The method according to claim 1, wherein the outputting of the warning signal is performed also under consideration of turbomolecular pump parameters and/or the ambient conditions.

27. The method according to claim 26, wherein, in the determination of the limiting value, the turbomolecular pump parameters and/or the ambient conditions are considered.

28. The method according to claim 26, wherein the determination of the limiting value is variable, with the limiting value being newly computed, preferably automatically.

29. The method according to claim 1, wherein a control signal is transmitted to the monitoring device at regular intervals.

30. The method according to claim 1, wherein a warning signal is generated when a first limiting value is exceeded.

31. The method according to claim 30, wherein, when a second limiting value is exceeded, the turbomolecular pump is switched off, preferably automatically.

32. A turbomolecular pump for performing the method according to claim 1, comprising
a pumping device arranged in a housing,
a vibration pick-up mechanically connected to the turbomolecular pump component which is to be monitored,
an evaluation unit electrically connected to the vibration pick-up, for evaluating the received vibration signal in dependence on comparison values, said evaluation unit comprising a filter which preferably is a frequency-filter circuit,
an output device connected to the evaluation unit, for outputting a signal when a limiting value is exceeded.

33. The turbomolecular pump according to claim 32, wherein the evaluation unit comprises a microprocessor for signal processing, said microprocessor preferably being the microprocessor of the turbomolecular pump.

34. The turbomolecular pump according to claim 32, wherein said filter is suited, by setting a frequency, for detection of a corresponding vibration amplitude and preferably is frequency-variable by being set to different frequencies.

35. The turbomolecular pump according to claim 32, wherein the evaluation unit is operative to detect a vibration amplitude for at least one frequency.

36. The turbomolecular pump according to claim 32, wherein the evaluation unit comprises a storage element for storing comparative values.

37. The turbomolecular pump according to 32, comprising a determining device for determining turbomolecular pump parameters and/or ambient conditions.

38. The turbomolecular pump according to claim 37, wherein the evaluation unit comprises a limiting-value adapting device for adapting the limiting value in dependence on the detected turbomolecular pump parameters and/or the detected ambient conditions.

39. The turbomolecular pump according to claim 32, wherein the evaluation unit is connected to a monitoring device via a remote data transmission system.
